(19) United States
(12) Patent Application Publication
(10) Pub. No.: US 2006/0155615 A1
(43) Pub. Date: Jul. 13, 2006

(54) Object placement within computer generated multidimensional environments

(75) Inventors: Siang L. Loo, Lynnwood, WA (US); Andrew V. Yoder, Seattle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WildTangent, Inc.

(21) Appl. No.: 11/317,875

(22) Filed: Dec. 22, 2005

Related U.S. Application Data
(60) Provisional application No. 60/642,322, filed on Jan. 7, 2005.

(51) Int. Cl. G07F 7/00; G07G 1/14; G06T 15/00

(52) U.S. Cl. 705/27; 705/14; 345/419

(57) ABSTRACT

A system, apparatus and method for measuring efficacy of an object placed in a virtual multi-dimensional environment are described herein.

### CROSS-REFERENCE TO RELATED APPLICATION

This application claims the benefit of U.S. Provisional Application Ser. No. 60/642,322 filed Jan. 7, 2005, which specification is hereby incorporated by reference.

### FIELD OF THE INVENTION

Embodiments of the present invention relate to the fields data processing and commercial communication within virtual multidimensional environments. More specifically, embodiments of the present invention relate to methods and apparatus for optimizing placement of objects in a computer generated multidimensional environment and/or the monitoring and collecting of data regarding relative efficacy of each object placed within the virtual multidimensional environment; and their applications to commercial communication.

### BACKGROUND

Various applications may benefit from optimal placement of objects in multi-dimensional virtual environments. For example, commercial communication, such as advertising, is only useful when desired objects bearing the advertisements and/or subject matter are properly transmitted and understood by a target audience. Unfortunately, commercial communications are not equally effective in conveying their messages to the target audience. Accordingly, the objects bearing the advertisements and/or subject matter of commercial communication using one methodology are not always delivered as successfully as another methodology might be for the same commercial communication.

One common metric for measuring relative advertising effectiveness, known in the art for both physical and electronic advertising, is based on the amount of time an object and/or advertisement is displayed or exposed for “viewing” by a user. This is common for commercial communication in the physical world as well as commercial communication in virtual computer generated worlds, such as virtual multidimensional environments. For example, in the physical world, a common metric for measuring the effectiveness of road side billboards is the number of cars which drive past the location each day. This approach assumes that each car that is counted will be driving in the same direction and at the same relative speed so they are exposed to the billboard for approximately the same amount of time. More specifically, the standard “time visible” approach is a heuristic algorithm used to estimate the impact the object has had on the person. Thus, the underlying assumption of “time visible” approaches being that if the object is available for “viewing” to a person, then the person is assumed to have “seen it” and the object will have had an impact. Similar “time visible” metrics have been devised for advertising in interactive multidimensional environments for participating users.

Metrics based solely on “display time” or “time visible” are limited and do not fully utilize supplemental information to more effectively assess the efficacy of a commercial communication. For example, these conventional simple “time visible” metrics do not take into considerations whether the commercial communication may have been obstructed or obscured, the time exposure may have been too short, the graphical attributes of the communication may be incompatible with the context (e.g., a communication with many white colored graphics or text being exposed on a snowing day), and so forth. In fact, the “time visible” heuristic approach will produce metrics that are overly optimistic in many circumstances. As such, the underlying “time visible” implementations perform poorly in identifying the relative value and impact of an object “visible” at a certain location on a participating user.

More specifically, the underlying assumption of “time visible” approaches may be flawed in the multidimensional computer generated environment, because even when an object is in view of a participating user or person, the user may not “see it”, thereby eliminating any potential impact of the object.

### BRIEF DECRIPTION OF THE DRAWINGS

The present invention will be described by way of exemplary embodiment, but not limitations, illustrated in the accompanying drawings in which like references denote similar elements, and in which:

FIG. 1 illustrates a computing environment suitable for practicing various embodiments of the present invention;

FIG. 2 illustrates a computing device suitable for practicing various embodiments of the present invention;

FIG. 3 illustrates a flowchart view of a portion of the operations of a computing device as presented in FIG. 1 and FIG. 2 in further detail, in accordance with various embodiments;

FIG. 4 illustrates a flowchart view of a portion of the operations of a computing device as presented in FIG. 1 and FIG. 2 in further detail, in accordance with various embodiments;

FIG. 5 illustrates a block diagram overview of the present invention, in accordance with one embodiment; and

FIGS. 6-12 illustrate various factors employed in the determination of a metric M as presented in FIG. 5 for the determination of placement of an ad/object, in accordance with various embodiments.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment, but it may. The phrase “A/B” means “A or B”. The phrase “A and/or B” means “(A), (B), or (A and B)”. The phrase “at least one of A, B, and C” means “(A), (B), (C), (A and B), (A and C), (B and C) or (A, B and C)”. The phrase “(A) B” means “(A B) or (B)”, that is “A” is optional.

In view of the difficulties previously discussed with currently available metrics for digital commercial communication that are based solely on “display time” or “time visible” and the limitations of other available solutions, at least one embodiment of the present invention has been developed to satisfy the need for assessing and comparing multiple properties or factors contributing to the impact and/or value of an object within the virtual environment. Accordingly, a computing device is provided in at least one embodiment of the invention that is configured to measure the efficacy of an object placed in a virtual multidimensional environment, including collecting data on a plurality of factors contributing to efficacy of a placement of an object in the virtual multidimensional environment, and computing an efficacy metric based at least in part on the data collected for the efficacy contributing factors. Exemplary contributing factors may include, but are not limited to, scale, frequency, quantity, attentiveness, involvement, capacity, and engagement.

A metric, as used herein, refers to a standard of measurement for assessing and comparing multiple properties or contributing factors. Contributing factors, as used herein, may include at least one of scale, frequency, quantity, attentiveness, involvement, capacity, and engagement. Generally, the metric is a quantity which indicates the impact and/or value of an object at a certain location. A metric may be computed or assigned to each object or each object location within a multidimensional computer generated environment.

In accordance with a further feature of at least one embodiment, the object is an advertisement. Moreover, according to an additional feature of at least one embodiment, the object includes one or more media selected from the group consisting of audio, video, texts and graphics. Accordingly, a metric may be used with commercial communication, such as advertising, to indicate the impact and/or value of an advertisement within the virtual environment.

A multidimensional environment may include 2D and 3D computer generated virtual environments or some combination thereof. The multidimensional environment may be a game environment, a virtual reproduction of physical locations, an artificial rendering of an imaginary location, an educational training environment, a simulated environment, and/or any combination thereof. Moreover, various embodiments may use multidimensional environments that are configured for a single user, multiple users, or partial combinations thereof where portions are designed for a single user and other portions are designed for multiple users to interact. Embodiments may also render the virtual multidimensional environment on a host machine and/or on a server based system.

A “player” or “user” as used herein may, in addition to the virtual character rendered in the multidimensional environment, also refer to a participant, a user, and/or a person interacting with the multidimensional environment. Additionally, use of “player” terminology does not necessarily indicate participation in a game or gaming environment, but it may.

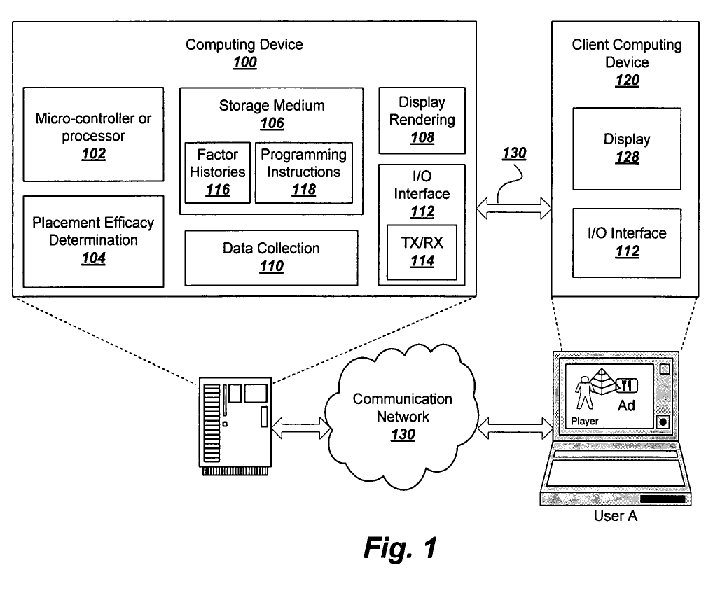

Referring now to FIG. 1, an architectural view of a computing device 100 and a client computing device 120 are shown. The computing device 100 and the client computing device 120 may include general and/or special purpose computing devices, such as a desktop computer, a personal digital assistant (PDA), a mobile phone, a GPS system, a server, and/or a game console suitably configured for practicing the present invention in accordance with at least one embodiment. In one embodiment, high end phones may provide sufficient graphic functionality to include games and advertising. Moreover, one embodiment includes game console platforms configured to allow for online games and other media content. In one embodiment, a GPS systems configured to render sophisticated 3D maps, which may also include location based advertising into those 3D map renderings.

As illustrated, for the embodiment, computing device 100 includes micro-controller/processor 102, placement efficacy determination module 104, storage medium 106, display rendering module 108, data collection module 110, and Input/Output (I/O) controller 112 including a transmit/receive (TX/RX) module 114. Further, storage medium 106 includes factor histories 116 and programming instructions 118 adapted to implement the object placement method of the present invention, to be described more fully below. The specific implementation may be accomplished via any one of a number programming languages, assembly, C, XML, Java, and so forth.

In one embodiment, the virtual multidimensional environment is rendered on a display of a first computing device, the collecting operation is performed on a second computing device, and the determining operation is performed on a third computing device. In accordance with again an additional feature of one embodiment, either the first and second computing devices are the same computing device and/or the second and third computing devices are the same computing device. In still another embodiment, the rendering, the collection and the determining operations are all performed on the same computing device. The latter configuration is illustrated in FIG. 1, where the client computing device 120 includes a display 128 and an I/O interface 112 configurable to selectively communicate with the I/O interface 112 of the computing device 100 to receive bitmaps of displays from computing device 100. The rendering of the multi-dimensional virtual environment in the form of display bitmaps is performed by the display rendering module 108 of computing device 100. The collecting operation is performed by the data collection module 110 on the computing device 100 and the determining operation is performed by the placement efficacy determination module 104 on the computing device 100. In one embodiment the client computing device 120 displays the rendered object in the display 128, in accordance with data received from the display rendering module 108 of the computing device 100.

In accordance with yet an additional feature of one embodiment, the object in the display 128 includes one or more media selected from the group consisting of audio, video, texts and graphics. For example, a player might hear the object, view a video clip from the object, read the object, and/or see the object. In one embodiment, the type of object provided might be dependent on conditions within the virtual multidimensional environment relative to the player. For example, in a dark virtual environment, use of an audio object or an illuminated object might be more effective. By comparing the metric for each available object, selection of the specific most effective object may be made.

In the illustrated embodiment of FIG. 1, computing device 100 is functioning as a server/host for the client computing device 120. However, in alternative embodiments, the computing device 100 and client computing device 120 may both be either a server or a client. Whether as a server or client, computing device 100 may be coupled to clients or server via communication network 130, which may include wireless and/or wireline based interconnection over one or more private and/or public networks, including the famous public network “Internet”.

In one embodiment, the computing device 100 is configured to collect data at the data collection module 110 on a plurality of factors contributing to efficacy of a placement of an object in a virtual multidimensional environment and in a placement efficacy determination module 104 to compute an efficacy metric based at least in part on the data collected for each of the relevant efficacy contributing factors.

In accordance with a feature of one embodiment, players associated with a plurality of client computing devices 120 each interacts with the virtual multidimensional environment, such that for a placement of an object within the virtual multidimensional environment, player specific data on a plurality of contributing factors is collected individually and the effectiveness metric is computed on a player by player basis for at least one of the one or more players.

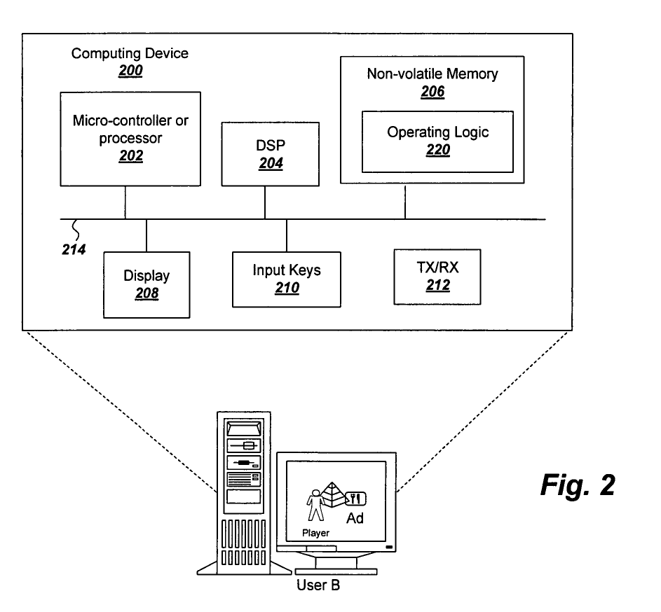

Referring now to FIG. 2, showing an architecture view of a computing device 200, such as a desktop computer, a PDA, a mobile phone, or a game console (in other words, a general or special purpose computing device), suitable for practicing the present invention in accordance with at least one embodiment. Computing device 200 may be a server or a client. Whether as a server or client, computing device 200 may be coupled to clients or server via a wireless or wireline based interconnection, over one or more private and/or public networks, including the famous public network “Internet”.

As illustrated, for the embodiment, computing device 200 includes elements found in conventional computing device, such as micro-controller/processor 202, digital signal processor (DSP) 204, non-volatile memory 206, display 208, input keys 210 (such as 12 key pad, select button, D-unit), and transmit/receive (TX/RX) 212, coupled to each other via bus 214, which may be a single bus or an hierarchy of bridged buses. Further, non-volatile memory 206 includes operating logic 220 adapted to implement one or more embodiments of the ad/object placement method of the present invention, to be described more fully below.

Except for their support of the novel end user interface, the functions and constitutions of the various enumerated elements of FIG. 2 are known in the art and, accordingly, will not be otherwise further described.

In alternate embodiments, all or portions of the operating logic 220 may be implemented in hardware, firmware, or a combination thereof. Hardware implementations may be in the form of application specific integrated circuit (ASIC), reconfigured reconfigurable circuits (such as Field Programming Field Array (FPGA)), and so forth.

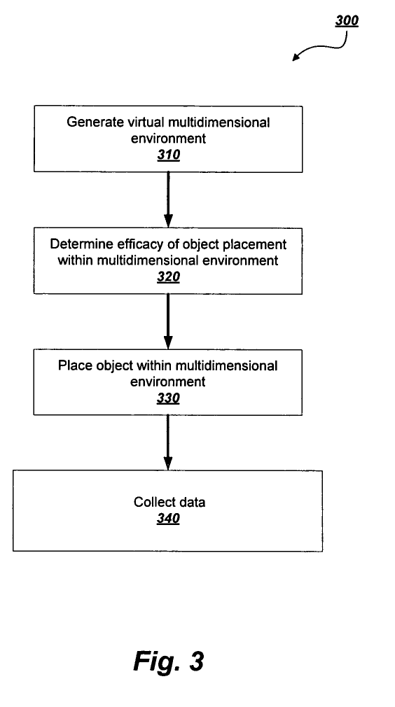

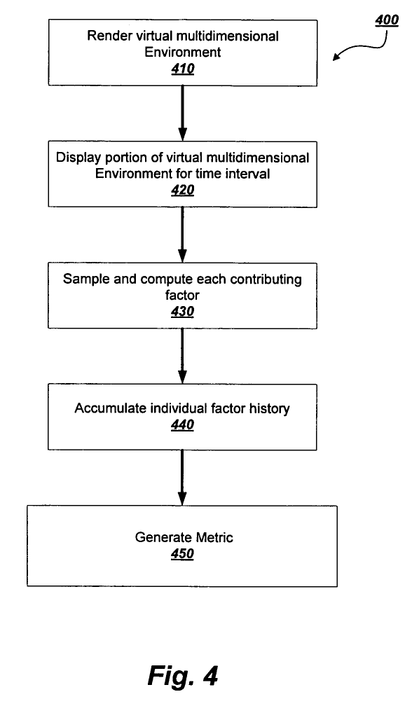

Turning now to FIGS. 3 and 4, wherein various methods of operation of the computing devices of FIG. 1 and FIG. 2, in accordance with various embodiments, are illustrated. The operational method/process 300 in FIG. 3 illustrates object placement based in part on efficacy projections, while the operational method/process 400 in FIG. 4 illustrates metric generation based on historical factor analysis.

Referring now to FIG. 3, wherein a portion of the operations of a computing device (e.g., 100 and 120 and 200), in accordance with various embodiments, is illustrated. Collectively, these operations shall be referred to as operational method/process 300.

Upon activation, the computing device may provide/render/generate a virtual multidimensional environment in block 310. As previously indicated, the virtual multidimensional environment may include 2D and/or 3D computer generated virtual environments for a single player and/or multiple players. Moreover, in at least one embodiment, the virtual multidimensional environment may be a game environment, a virtual reproduction of the real world environment, an imaginary environment, an educational training environment, a simulated environment, and/or any combination thereof. In accordance with again another feature of at least one embodiment, the virtual multidimensional environment includes one or more scenes of a game.

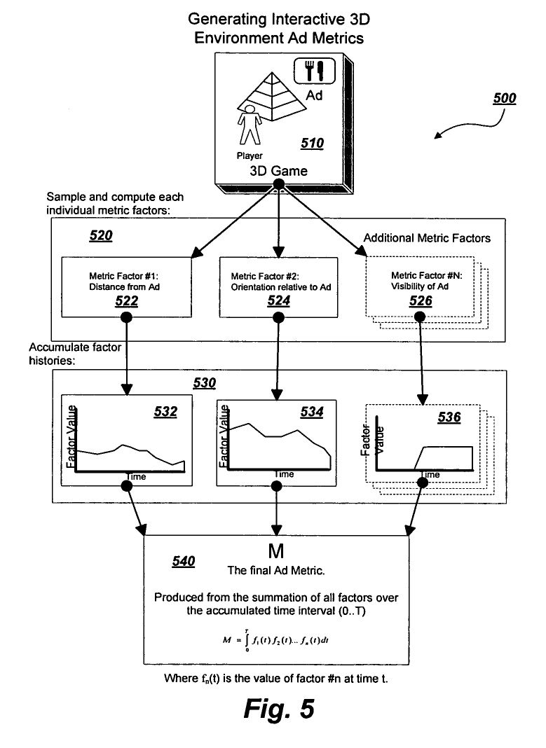

In block 320, the operational method/process 300 determines the efficacy of various potential object placements. In various embodiments, operational method/process 300 determines placements of an object in a generated multidimensional environment based in part on a metric M (e.g., item 540 produced by a summation of all the contributing factors over the specified time interval in FIG. 5) for assessing and comparing multiple properties to indicate the relative value and/or impact of an object being placed at a certain location within the virtual multidimensional environment.

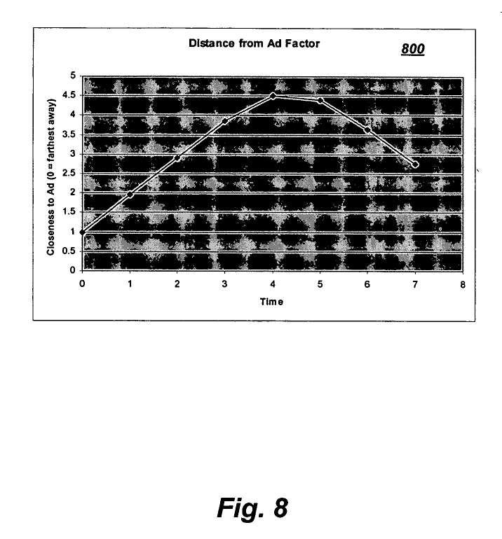

Upon placing the object in block 330 within the virtual multidimensional environment based on the efficacy projection, the process 300 begins collecting data for various contributing factors in block 340. In accordance with another feature of one embodiment, at least one of the contributing factors is a distance factor, where the process 300 collects data on a player's distance relative to the placement of the object during a time period the object is rendered at least in part in the virtual multidimensional environment. Exemplary distance factors are discussed in more detail below with reference to FIG. 8.

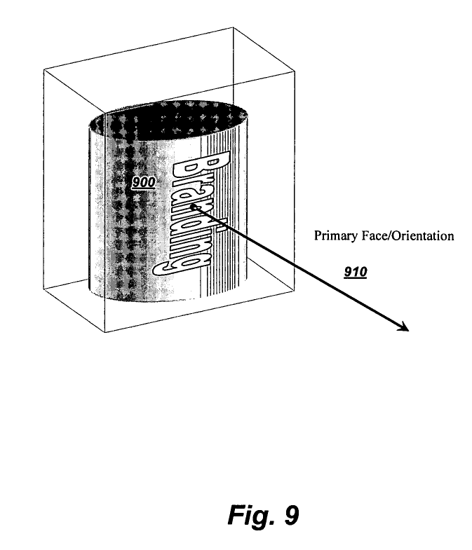

In accordance with a further feature of one embodiment, at least one of the contributing factors is an orientation factor, where the process 300 collects data on the object's orientation relative to the player during a time period the object is rendered at least in part in the virtual multidimensional environment. Exemplary orientation and alignment factors are discussed in more detail below with reference to FIGS. 9-11.

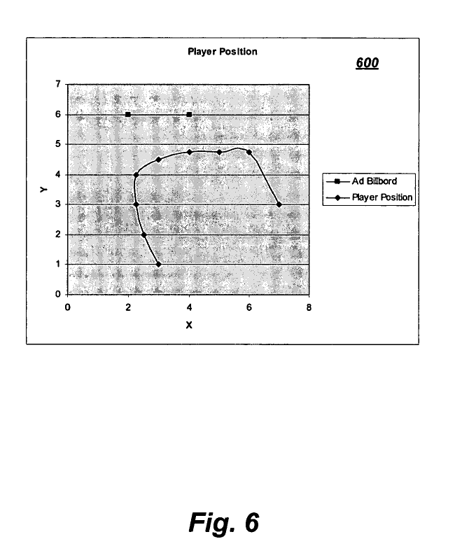

In accordance with an added feature of one embodiment, at least one of the contributing factors is a movement factor, where the process 300 collects data associated with relative movement of the object and a player during a time period the object is rendered at least in part in the virtual multidimensional environment. Exemplary relative movement factors are discussed in more detail below with reference to FIG. 6.

In accordance with an additional feature of one embodiment, at least one of the contributing factors is an environmental factor, where the process 300 collects data associated with one or more environmental attributes relative to a player during a time period the object is rendered at least in part in the virtual multidimensional environment. Environmental effects typically attempt to reduce a user perception of an object and concern the conditions by which the player observes the object. In accordance with yet another feature of one embodiment, the one or more environmental attributes comprise one or more selected from the group consisting of fogging (fog/smog), darkening (twilight, night), fading (sunrise, sunset), blurring (rain), sparkling/glaring (sun or reflection from snow), and the like. For instance the game might employ “fogging” to fade objects out the farther they are from the player in the virtual environment. As such, an object might be visible, but highly “fogged” to prevent the player from truly seeing the object.

Another example of an environmental effect is lighting. An object may technically be “visible” (e.g., the 3D object is projected to 2D locations which reside within the view screen limits) but current lighting conditions may prevent recognition of the object. For instance, a room in a game might contain an object on the wall. The lights may be off in the room. If the player passes through the room without turning on the lights the metric really should not be improved by the user passing through the unlit room, however under a pure “time visible” metric without the nuanced understanding of lighting conditions would count the user's time in the room as time that the object was “seen”. However, if the object on the wall was glowing or flashing, the unlit status of the room would actually amplify the effect, since the object would now be the source of light in the room.

In accordance with yet a further feature of one embodiment, at least one of the contributing factors is a graphics factor, where the process 300 collects data associated with a plurality graphical attributes relative to a player during a time period the object is rendered at least in part in the virtual multidimensional environment. Graphical factors typically attempt to amplify user perception of an object. Graphics factors, in contrast to environmental factors, are graphical effects which draw player attention to an object. In accordance with yet an added feature of one embodiment, the one or more graphical attributes comprise one or more selected from the group consisting of glowing, blinking, flashing, twinkling, dripping, sparkling, blazing, pulsing, glittering, rotating, and the like.

In various embodiments, the object metric may be used to determine pricing for ads to be placed as objects within the virtual environment by advertisers. The pricing may be on a sliding scale such that the metric value determines price. This allows advertisers to only pay for ads which are seen in situations where the user can reasonably be expected to have perceived the ad and its product.

In other embodiments, the metric is used to aid in determining the best placement of ads within a multidimensional environment. Invisible “ad” objects could be initially scattered throughout a multidimensional environment. Then metrics are collected for all of these objects as players interact with the multidimensional world. The metrics that become associated with each hidden object can then be used to rank each location according to its appropriateness as a location for real advertising.

Referring now to FIG. 4, wherein a portion of the operations of a computing device (e.g., 100 and 120 and 200), in accordance with at least one embodiment is illustrated. Collectively, these operations shall be referred to as operational method/process 400.

The process 400 renders the virtual multidimensional environment in block 410. In block 420, at least a portion of the rendered virtual multidimensional environment is displayed for a designated time interval. Concurrent with the display operation in block 420, the process 400 samples and computes each contributing factor in block 430 and accumulates individual contributing factor history in block 440. Upon accumulating sufficient historical data, the process 400 may generate a metric value in block 450 for the object based on the contributing factors.

In at least one embodiment, various data factors are used in the production of metric M by using the following expression:

$$M = {\int }_{0}^{T} {f}_{1} ( t ) {f}_{2} ( t ) … {f}_{n} ( t ) ⅆ t$$

Where M is the object metric, t is time the time variable (ranging from 0 to T) and fᵢ(t) is the value at time t of a contributing factor to the metric.

The metric expression above for M multiplies together many factors and then computes the area under the resulting curve to generate a realistic metric of player recognition of an object. The area under the curve can be produced using any number of numerical integration techniques. For the embodiments where the contributions of the factors are combined by multiplying the contributions, factors that have a value of 0 at a specific time will cause the metric to have a value of 0 at that time. For example, when the lights are off in a virtual room the other “proximity” related factors don't matter to the object so the metric should be zero.

In other embodiments, other mathematical operations beside multiplication may be employed to combine the contributions of the various factors instead. For example, if an object consisted of audio, video, texts, and graphics, then the overall impact/effect of the object could be measured by the summation of each component metric value (audio, video, texts, and graphics). In one embodiment, each component is iteratively computed. Another example, returns to our dark room from the example provided above, if one of the features of the object is a flashing neon sign the affect would actually be amplified over a well lit room. As such, the light component might be zero, but the flashing component would be non-zero resulting in an overall positive metric value.

The method of determining/calculating M, as expressed above, provides a method for assessing and comparing multiple properties or factors contributing to the overall impact and/or value of an object within a virtual environment. Reliance on multiple factors can significantly increase the accuracy of the metric over the traditional “time visible” metric, which provides only one factor upon which the metric is based, whereas the described improved metric M includes a method of combining an arbitrary number of factors (of which “time visible” can be one).

In the expression above, M depends critically on generating a series of factors (f₁ . . . fₙ) each of which accurately gauges an aspect of player interest in/recognition of the object.

Each factor may also be produced in identical fashion for each object or, if necessary, objects may have data associated with them that weight and aid in the computation of some factors. For instance, some objects with a text component may use large print and others small print. Each of these objects could be associated with data that indicated the maximum distance a player can be from the object and still read/recognize the text. This associated data could be used in computing an “average distance” factor in such a way that all distances outside of the maximum for that object are ignored.

In various embodiments, one or more of the factors discussed below are employed to contribute to the determination M. Each of these factors serves to correct at least in part the inaccuracies in the “time visible” metric (as listed previously). However, it should be noted that embodiments of the present invention are not limited to employing these factors. In various embodiments, more or less factors may be employed.

An overview of this process is illustrated for one embodiment in FIG. 5, where process 500 generates an ad within a 3D game environment to derive a final ad metric which accurately assesses and compares multiple properties to indicate the relative value and/or impact of the ad at a certain location. The process 500 of the present invention, in accordance with one embodiment, begins by generating and placing the ad in 510. Once the Ad is placed within the 3D game environment, the process 500 begins to sample and compute each of the individual metric factors in 520. More specifically, in 522 the process 500 determines a player's distance from the Ad. This can be accomplished in a variety of ways including using a positional graph as provided in FIG. 6. Once the distance has been determined a relative factor value to optimal conditions may be calculated as provided in FIG. 8, which indicates how distance will affect the overall metric.

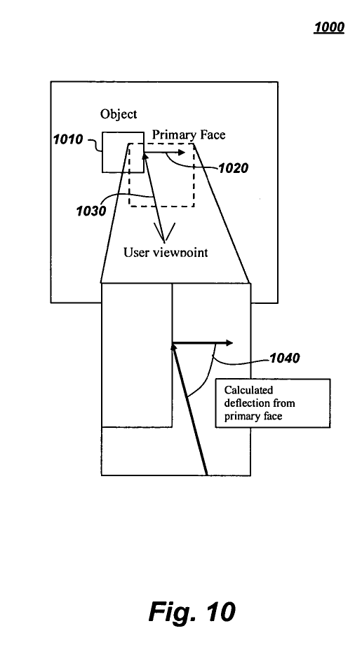

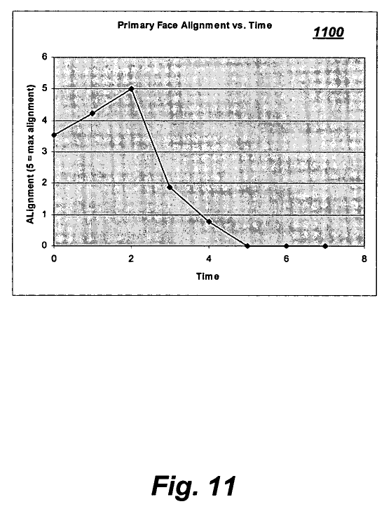

Another metric factor collected by the process 500 is the player's orientation to the Ad in 524. This is may be accomplished by comparing the primary face of the Ad as provided in FIG. 9 with the user viewpoint as shown in FIG. 10. The calculated deflection is one portion of the orientation factor, which may be combined with other portions such as horizontal and vertical alignment to generate an alignment or orientation factor as provided in FIG. 11.

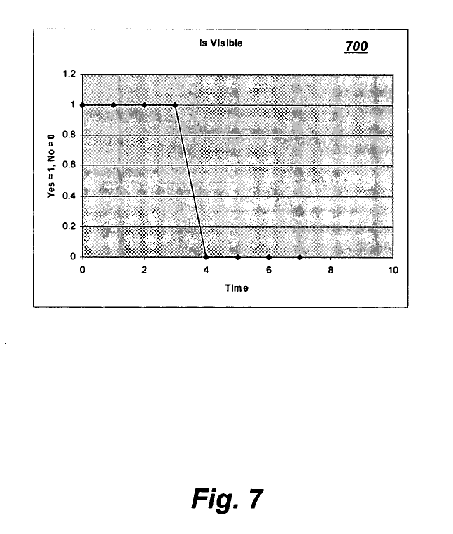

The process 500 may also consider other additional metric factors, such as the visibility of the Ad in 526 and as provided in FIG. 7. Although visibility is shown as either “Yes” or “No”, various environmental conditions could make the visibility factor variable, depending on their status. For example, if it was foggy, the visibility might be 0.8 instead of 1. Alternatively, the environmental and graphic factors could be considered separately as previously indicated in FIG. 3. Once the factor values have been determined in 520, the process 500 accumulates the factor histories in 530. For example, in FIG. 1, the computing device 100 via the storage medium 106 maintains a record of the factor histories 116 separately. In one embodiment, each factor value may be graphically represented (532, 534, 536) over time.

Once the process 500 has sampled the environment for the requisite time interval, the final ad metric is produced in 540 from the summation of all the factors over the accumulated time interval.

FIGS. 6-12 illustrate some of the factors employed in various embodiments. Specifically, FIG. 6 illustrates an example series of positions of a player/observer in the computer generated multidimensional environment.

Visibility Factor.

The “time visible” metric can be reformulated to be a factor of M by generating a sampling of points over time that are either 0 or 1. Zero indicates that the object is not visible at the sampled time t and 1 indicates that it is visible. A graph of the “is visible” factor (using the player position data from FIG. 6) is illustrated in FIG. 7:

Relative Distance Factor

In various embodiments, the relative distance from object factor increases in value the closer a player is to the object. For the embodiments, a threshold distance is defined, beyond which the object is considered to be unrecognizable. Using the Player Position data from FIG. 6 and setting the max distance to be 6 units the distance factor would appear as illustrated in FIG. 8.

Object Alignment Factors

This factor measures and accounts for the player's viewing angle with respect to the object. In various embodiments, the factor increases in value the closer the player is aligned with the normal of the object's primary face. Each object is associated with data that designates which face is its primary face. Objects which are non-cubic can define a bounding-box and designate one of the bounding box's faces as the primary face. For example, a soda can may designate a primary face as illustrated by FIG. 9.

Once the primary face of an object is known the player's alignment with that face can be calculated, as illustrated in FIG. 10.

Using the player position information previously listed, which assumes that the player faces towards the next positional location, a graph of the resulting primary face alignment would appear as illustrated in FIG. 11. In one embodiment, orientation is not necessarily tightly bound to positional information. For example, in at least one embodiment, a player could be moving backwards or sideways thereby significantly changing the related primary face alignment graph. Alternatively, the player might even be moving in one direction while looking in a different direction.

Data for the graph 1100 in FIG. 11 was produced by allowing alignment values to range from 0 (anti-alignment with primary face) to 5 (parallel alignment with the normal of the primary face). This scaling is an arbitrary choice and its value can be adjusted to control how much the Object Alignment Factor contributes to the overall value of M.

Vertical Object Orientation Factor

This factor is an adjunct to the Object Alignment factor, typically employed in situations, such as games where full 3D motion is possible. In such games it is possible for the player to be upside down with respect to the object (flight/space simulators are a good example of games that allow this kind of motion). In various embodiments, the vertical object orientation factor has a maximal value when the “up” vector of the object's primary face is aligned with the player's “up” vector. This factor has a minimal value when the object's “up” vector is in the opposite direction of the player's up vector.

Turn Rate Factor

In various embodiments, a separate factor which measures only relative turn rate is applied. In one embodiment, the turn rate factor is based on the turn rate of the object. In another embodiment, one turn rate factor is determined by turning of the player only. Yet another embodiment may consider another turn rate factor based on a measurement of relative turn rates of objects involved in the analysis (e.g., turn rates of both the player and the object combined).

Two exemplary cases where the turn rate factor may be used include when the object alignment factor is not used in the calculation of M and/or if extra weight is to be applied to the Turn Rate factor without simultaneously increasing the object alignment's contribution to M.

Environmental Factors.

This factor may be represented by several independent factors depending on what environmental effects are simulated by a usage, such as in a game. One example of an environmental effect is lighting. In various embodiments, a factor which captures lighting's effect on player perception of an object would result in a value of 0 for times when the object is entirely unlit. The factor could continuously increase in value up to an arbitrarily defined maximum at the point where the object is fully illuminated. This approach allows the metric (M) to “discount” user perception of an object the darker the scene.

Graphical and Audio Effect Factors.

Similar to environmental effects except that graphical and audio effects factors typically attempt to amplify user perception of an object rather than reduce it as environmental factors are apt to do. One factor may be used for each graphical or audio effect desired to be captured by M. In various embodiments, the value of a graphical effect factor would be 1 when the effect is inactive. A value of 1 allows the factor to be multiplied with other factors and cause no change in M. When the effect is on (some effects may exist on a continuum) it will have a maximum value that is determined by the weight the effect is intended to have on M. So, for instance, assuming a glowing pulsing effect can attach to objects and that this effect can be turned on at various brightness levels (i.e., between 0 and 100% brightness). In one embodiment, one may determine that when this effect is at 100% brightness it triples the likelihood that the player will “see” the object when compared with the effect being completely off. In this case, the factor associated with this effect would range from a value of 1 when the effect is at 0% to a value of 3 when the effect is set to 100% brightness.

2D Factors.

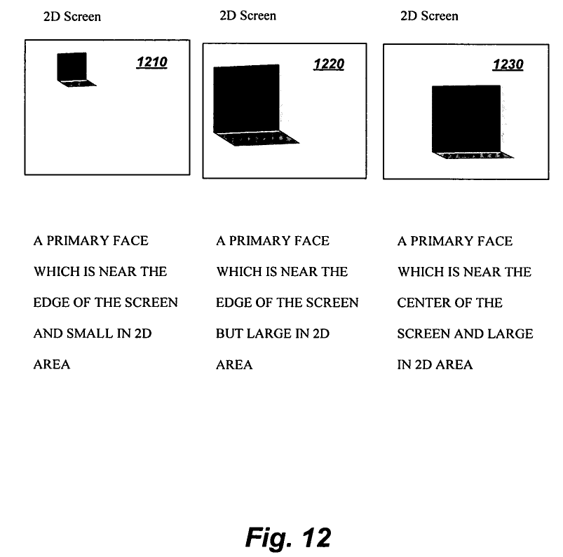

In various embodiments, several other contributing factors can be produced using data in 2D (after the scene has been rendered to the players screen). Three 2D factors are: object location on the user's screen (see e.g., 1210, 1220, and 1230), object size when projected onto the screen (see e.g., 1210, 1220, and 1230), positional stability of the object in 2D (FIG. 12).

With respect to 2D object location, in various embodiments, this factor is setup to produce higher values the closer the object is to the center of the screen and results in lesser values as the object is nearer to the edges of the screen.

The 2D object size or the 2D area of the object's primary face can also be used as a factor in various embodiments. This factor is similar to distance from the object and object alignment factors, but can be combined with this other factors to yield an improved metric. This is because a large 2D object size can indicate valuable object recognition even when the object alignment factor is low. The object may be difficult to read, but when it occupies a large amount of 2D real estate the object is difficult to ignore.

The location stability of the object in 2D for various embodiments, is a factor employed to indicate a high likelihood of the player reading/understanding the object. At any given time, other factors may report high values, but if those high values are transitory they cannot translate into meaningful object recognition. However, if the object remains relatively fixed or is slow moving in the 2D domain, the player is able to read and recognize the object. The location stability factor is different from most other factors because it exhibits a cumulative property rather than reporting an instantaneous value at a particular sample time. In various embodiments, the value of the location stability factor at any point in time is based on the history (over the last X seconds) of the 2D location of the center of the object's primary face. If the history of this point's 2D trajectory is relatively stable (does not move wildly across the screen), then a high value is returned by this factor. Similarly, if this trajectory is abrupt or exhibits high curvature then the value of the factor is low.

Although specific embodiments have been illustrated and described herein, it will be appreciated by those of ordinary skill in the art and others, that a wide variety of alternate and/or equivalent implementations may be substituted for the specific embodiment shown in the described without departing from the scope of the present invention. This application is intended to cover any adaptations or variations of the embodiment discussed herein. Therefore, it is manifested and intended that the invention be limited only by the claims and the equivalence thereof.

What is claimed is:

1. A quantitative method of measuring efficacy of an object placed in a virtual multidimensional environment, comprising:
collecting data on a plurality of factors contributing to efficacy of a placement of an object in the virtual multidimensional environment; and
computing an efficacy metric based at least in part on the data collected for the efficacy contributing factors.

2. The method as recited in claim 1, wherein one or more players interact with the virtual multidimensional environment, and wherein the collecting of data on the plurality of contributing factors and the computing of the effectiveness metric are performed for a placement of an object on a player by player basis for at least one of the one or more players.

3. The method as recited in claim 2, wherein at least one of the contributing factors is a distance factor, and the collecting comprises collecting data on a player's distance from the placement of the object during a time period the object is rendered at least in part in the virtual multidimensional environment.

4. The method as recited in claim 2, wherein at least one of the contributing factors is an orientation factor, and the collecting comprises collecting data on the object's orientation to the player during a time period the object is rendered at least in part in the virtual multidimensional environment.

5. The method as recited in claim 2, wherein at least one of the contributing factors is a movement factor, and the collecting comprises collecting data associated with relative movement of the object and a player during a time period the object is rendered at least in part in the virtual multidimensional environment.

6. The method as recited in claim 2, wherein at least one of the contributing factors is an environmental factor and the collecting comprises collecting data associated with one or more environmental attributes relative to a player during a time period the object is rendered at least in part in the virtual multidimensional environment.

7. The method as recited in claim 6, wherein the one or more environmental attributes comprise one or more selected from the group consisting of fogging (fog/smog), darkening (twilight, night), fading (sunrise, sunset), blurring (rain), and sparkling/glaring (sun or reflection from snow).

8. The method as recited in claim 2, wherein at least one of the contributing factors is a graphics factor, and the collecting comprises collecting data associated with a plurality graphical attributes relative to a player during a time period the object is rendered at least in part in the virtual multidimensional environment.

9. The method as recited in claim 8, wherein the one or more graphical attributes comprise one or more selected from the group consisting of glowing, pulsing, blinking, flashing, twinkling, dripping, sparkling, burning/flaming/blazing, and glittering.

10. The method as recited in claim 1, wherein the object comprises one or more media selected from the group consisting of audio, video, texts and graphics.

11. The method of claim 1, wherein the virtual multidimensional environment comprises one or more scenes of a game.

12. The method of claim 1, wherein the object is an advertisement.

13. The method of claim 1, wherein the virtual multidimensional environment is rendered on a display of a first computing device, the collecting is performed on a second computing device, and the determining is performed on a third computing device.

14. The method of claim 13, wherein either the first and second computing devices are the same computing device or the second and third computing devices are the same computing device.

15. An object placement method for virtual multidimensional environments, comprising:
determining efficacy of placing an object in a plurality of locations of a virtual multidimensional environment based at least in part on a plurality of efficacy contributing factors measured for each of the placements relative to a player interacting with the virtual multidimensional environment; and
placing the object in one of the locations based at least in part on the determined efficacy of the placements.

16. The method of claim 15, wherein determining efficacy of placing an object in a location of the virtual multidimensional environment comprises
collecting data on the efficacy contributing factors for the placement; and
computing an efficacy metric based at least in part on the data collected for the efficacy contributing factors.

17. The method of claim 16, wherein the collecting and computing are repeated for each of the placements.

18. The method of claim 16, wherein the efficacy contributing factors comprise a plurality of selections from the group consisting of
a distance factor measuring the player's distance from the placement during a time period the placed object is rendered at least in part in the virtual multidimensional environment,
an orientation factor measuring the placed object's orientation to the player during a time period the placed object is rendered at least in part in the virtual multidimensional environment,
a movement factor measuring relative movement of the placed object and the player during a time period the placed object is rendered at least in part in the virtual multidimensional environment,
an environmental factor measuring one or more environmental attributes relative to the player during a time period the placed object is rendered at least in part in the virtual multidimensional environment, and
a graphics factor measuring one or more graphics attributes relative to the player during a time period the placed object is rendered at least in part in the virtual multidimensional environment.

19. The method of claim 15, wherein the virtual multidimensional environment comprises one or more scenes of a game, and the object is an advertisement.

20. The method of claim 15, wherein the virtual multidimensional environment is rendered on a display of a first computing device, the collecting is performed on a second computing device, and the determining is performed on a third computing device.

21. The method of claim 20, wherein either the first and second computing devices are the same computing device or the second and third computing devices are the same computing device.

22. An advertising method for virtual multidimensional environments, comprising:
determining efficacy of placing an object in a location of a virtual multidimensional environment based at least in part on a plurality of efficacy contributing factors measured for the placement relative to a player interacting with the virtual multidimensional environment; and
determining a compensation for the placement based on the determined efficacy of the placement.

23. The method of claim 22, wherein said determining comprises collecting data on the efficacy contributing factors for the placement; and computing an efficacy metric based at least in part on the data collected for the efficacy contributing factors.

24. The method of claim 22, wherein the efficacy contributing factors comprise a plurality of selections from the group consisting of
a distance factor measuring the player's distance from the placement during a time period the placed object is rendered at least in part in the virtual multidimensional environment,
an orientation factor measuring the placed object's orientation to the player during a time period the placed object is rendered at least in part in the virtual multidimensional environment,
a movement factor measuring relative movement of the placed object and the player during a time period the placed object is rendered at least in part in the virtual multidimensional environment,
an environmental factor measuring one or more environmental attributes relative to the player during a time period the placed object is rendered at least in part in the virtual multidimensional environment, and
a graphics factor measuring one or more graphics attributes relative to the player during a time period the placed object is rendered at least in part in the virtual multidimensional environment.

25. A computing device comprising:
a data collection module adapted to collect data on a plurality of factors contributing to efficacy of a placement of an object in a virtual multidimensional environment; and
a placement efficacy determination module operatively coupled to the data collection module, and adapted to compute an efficacy metric based at least in part on the data collected for the efficacy contributing factors.

26. The computing device of claim 25, wherein the data collection module is adapted to collect data for one or more efficacy contributing factors selected from the group consisting of
a distance factor measuring the player's distance from the placement during a time period the placed object is rendered at least in part in the virtual multidimensional environment,
an orientation factor measuring the placed object's orientation to the player during a time period the placed object is rendered at least in part in the virtual multidimensional environment,
a movement factor measuring relative movement of the placed object and the player during a time period the placed object is rendered at least in part in the virtual multidimensional environment,
an environmental factor measuring one or more environmental attributes relative to the player during a time period the placed object is rendered at least in part in the virtual multidimensional environment, and
a graphics factor measuring one or more graphics attributes relative to the player during a time period the placed object is rendered at least in part in the virtual multidimensional environment.

27. The computing device of claim 25, comprising a storage medium having stored therein first and second plurality of programming instructions adapted to implement the data collection module and the placement efficacy determination module respectively, and a processor coupled to the storage medium to execute the first and second programming instructions.

28. The computing device of claim 25, wherein the virtual multidimensional environment is rendered on a selected one of the computing device and a client device coupled to the computing device.

29. An electronic device comprising:
a virtual environment creation module adapted to create a multidimensional virtual environment on the electronic device; and
a data collection module coupled to the virtual environment creation module, and adapted to collect data on a plurality of factors contributing to efficacy of a placement of an object in the virtual multidimensional environment.

30. The electronic device of claim 29, wherein the data collection module is adapted to collect data for one or more efficacy contributing factors selected from the group consisting of
a distance factor measuring the player's distance from the placement during a time period the placed object is rendered at least in part in the virtual multidimensional environment,
an orientation factor measuring the placed object's orientation to the player during a time period the placed object is rendered at least in part in the virtual multidimensional environment,
a movement factor measuring relative movement of the placed object and the player during a time period the placed object is rendered at least in part in the virtual multidimensional environment,
an environmental factor measuring one or more environmental attributes relative to the player during a time period the placed object is rendered at least in part in the virtual multidimensional environment, and
a graphics factor measuring one or more graphics attributes relative to the player during a time period the placed object is rendered at least in part in the virtual multidimensional environment.

31. The computing device of claim 29, wherein the electronic device is a selected one of a general purpose of computer, a personal digital assistant (PDA), a mobile phone, a GPS system, and a game console.

32. The computing device of claim 29, wherein the virtual multidimensional environment is a computer generated 3D environment.

33. An article of manufacture comprising:
a storage medium;
first programming instructions implementing a data collection module adapted to collect data on a plurality of factors contributing to efficacy of a placement of an object in a virtual multidimensional environment; and
second programming instructions implementing a placement efficacy determination module adapted to compute an efficacy metric based at least in part on the data collected for the efficacy contributing factors.

34. An article of manufacture comprising:
a storage medium;
first plurality of programming instructions implementing a virtual environment creation module adapted to create a multidimensional virtual environment; and
second plurality of programming instructions implementing a data collection module adapted to collect data on a plurality of factors contributing to efficacy of a placement of an object in the virtual multidimensional environment.
